(19) United States
(12) Patent Application Publication
(10) Pub. No.: US 2026/0177761 A1
(43) Pub. Date: Jun. 25, 2026

(54) SIDE OPTICAL COUPLERS FOR ADVANCED PACKAGE ARCHITECTURES

(71) Applicant: Lightmatter, Inc., Boston, MA (US)

(72) Inventors: Omkar Karhade, Chandler, AZ (US); Stefan Pfnuer, Scotts Valley, CA (US); Sandeep Sane, Chandler, AZ (US); Sufi Ahmed, Chandler, AZ (US); Mitul Modi, Phoenix, AZ (US); Shreyash Bhattarai, Sunnyvale, CA (US); Jessie Rosenberg, Bedford, MA (US); Binoy Shah, Niskayuna, NY (US)

(73) Assignee: Lightmatter, Inc, Boston, MA (US)

(21) Appl. No.: 19/425,470

(22) Filed: Dec. 18, 2025

Related U.S. Application Data
(60) Provisional application No. 63/736,532, filed on Dec. 19, 2024.
(60) Provisional application No. 63/756,005, filed on Feb. 7, 2025.
(60) Provisional application No. 63/762,736, filed on Feb. 25, 2025.
(60) Provisional application No. 63/766,294, filed on Mar. 3, 2025.
(60) Provisional application No. 63/780,130, filed on Mar. 28, 2025.
(60) Provisional application No. 63/925,412, filed on Nov. 25, 2025.

(51) Int. Cl. G02B 6/42

(52) U.S. Cl. CPC G02B 6/4214; G02B 6/4292

(57) ABSTRACT

A device may include an electronic-photonic assembly comprising: a photonic integrated circuit (PIC) comprising a waveguide extending near a sidewall of the PIC, an electronic integrated circuit (EIC) attached to the PIC; and an encapsulant at least partially encapsulating the EIC. A device may include an optical assembly comprising a detachable plug and a fiber attached to the detachable plug. A device may include an optical coupler between the sidewall of the PIC and the optical assembly, wherein the optical coupler is configured to couple light received from the waveguide to the fiber.

### CROSS-REFERENCE TO RELATED APPLICATIONS

This application claims the benefit of U.S. Provisional Application Ser. No. 63/736,532, filed on Dec. 19, 2024, under Attorney Docket No. L0858.70112US00 and entitled “EXPOSED COUPLER MOLDED ARCHITECTURE FOR OPTICAL DEVICES;” U.S. Provisional Application Ser. No. 63/756,005, filed on Feb. 7, 2025, under Attorney Docket No. L0858.70112US01 and entitled “OPTICAL COUPLERS FOR OPTICAL DEVICES;” U.S. Provisional Application Ser. No. 63/762,736, filed on Feb. 25, 2025, under Attorney Docket No. L0858.70112US02 and entitled “MOLDED COLLIMATED LENS ARCHITECTURE FOR 3D OPTICAL PACKAGES;” U.S. Provisional Application Ser. No. 63/766,294, filed on Mar. 3, 2025, under Attorney Docket No. L0858.70112US03 and entitled “EXPOSED COUPLER MOLDED ARCHITECTURE FOR OPTICAL DEVICES;” U.S. Provisional Application Ser. No. 63/780,130, filed on Mar. 28, 2025, under Attorney Docket No. L0858.70112US04 and entitled “EXPOSED COUPLER MOLDED ARCHITECTURE FOR OPTICAL DEVICES;” U.S. Provisional Application Ser. No. 63/925,412, filed on Nov. 25, 2025, under Attorney Docket No. L0858.70112US05 and entitled “EXPOSED COUPLER MOLDED ARCHITECTURE FOR OPTICAL DEVICES,” each of which is hereby incorporated herein by reference in its entirety.

### BACKGROUND

As data communications systems continue to scale to meet ever-increasing bandwidth demands, the limitations of traditional copper data channels have become increasingly apparent. Signal attenuation, crosstalk, and electromagnetic interference pose significant challenges, which can be partially mitigated through techniques such as equalization, coding, and shielding. However, these approaches often require substantial power, complexity, and cable bulk, offering only modest improvements in reach and limited scalability. Optical communication has emerged as a promising successor to copper links, offering the potential to overcome these limitations.

### BRIEF SUMMARY

In some aspects, the techniques described herein relate to a photonic device, including: an electronic-photonic assembly including: a photonic integrated circuit (PIC) including a waveguide extending near a sidewall of the PIC; an electronic integrated circuit (EIC) attached to the PIC; and an encapsulant at least partially encapsulating the EIC; an optical assembly including a detachable plug and a fiber attached to the detachable plug; and an optical coupler between the sidewall of the PIC and the optical assembly, wherein the optical coupler is configured to couple light received from the waveguide to the fiber.

In some aspects, the techniques described herein relate to a photonic device, wherein the optical coupler includes: a first reflective portion configured to reflect the light received from the waveguide in a first direction that is angled relative to a plane defined by the waveguide; and a second reflective portion configured to reflect the light reflected by the first reflective portion in a second direction that is parallel to the plane defined by the waveguide.

In some aspects, the techniques described herein relate to a photonic device, wherein the first and second reflective portions are angled by approximately 45° relative to the plane defined by the waveguide.

In some aspects, the techniques described herein relate to a photonic device, wherein the optical coupler is made of silicon.

In some aspects, the techniques described herein relate to a photonic device, wherein the PIC defines a recess near an edge of the PIC, and wherein the optical coupler is disposed in the recess.

In some aspects, the techniques described herein relate to a photonic device, wherein the optical coupler extends through the encapsulant.

In some aspects, the techniques described herein relate to a photonic device, wherein the optical coupler includes a collimator configured to collimate the light received from the waveguide.

In some aspects, the techniques described herein relate to a photonic device, wherein the collimator includes a convex surface.

In some aspects, the techniques described herein relate to a photonic device, including: a chip-on-wafer-on-substrate (CoWoS) package including an interposer and an electronic-photonic assembly disposed on the interposer, the electronic-photonic assembly including: a photonic integrated circuit (PIC) including a waveguide extending near a sidewall of the PIC; an electronic integrated circuit (EIC) attached to the PIC; and a first encapsulant at least partially encapsulating the EIC; an optical assembly including a detachable plug and a fiber attached to the detachable plug; an optical coupler between the sidewall of the PIC and the optical assembly, wherein the optical coupler is configured to couple light received from the waveguide to the fiber; and a second encapsulant at least partially encapsulating the electronic-photonic assembly.

In some aspects, the techniques described herein relate to a photonic device, further including second and third EICs disposed on the interposer, wherein the interposer places the electronic-photonic package in electrical communication with at least one between the second and third EICs.

In some aspects, the techniques described herein relate to a photonic device, wherein: the first EIC includes electronic circuitry configured to control active photonic circuitry of the PIC, the second EIC includes a processing chip, and the third EIC includes a high-bandwidth memory.

In some aspects, the techniques described herein relate to a photonic device, wherein the optical coupler includes: a first reflective portion configured to reflect the light received from the waveguide in a first direction that is angled relative to a plane defined by the waveguide; and a second reflective portion configured to reflect the light reflected by the first reflective portion in a second direction that is parallel to the plane defined by the waveguide.

In some aspects, the techniques described herein relate to a photonic device, wherein the first and second reflective portions are angled by approximately 45° relative to the plane defined by the waveguide.

In some aspects, the techniques described herein relate to a photonic device, wherein the PIC defines a recess near an edge of the PIC, and wherein the optical coupler is disposed in the recess.

In some aspects, the techniques described herein relate to a photonic device, wherein the optical coupler includes a collimator configured to collimate the light received from the waveguide.

In some aspects, the techniques described herein relate to a photonic device, wherein the collimator includes a convex surface.

In some aspects, the techniques described herein relate to a method for fabricating a photonic device, including: obtaining a semiconductor wafer having a waveguide; forming a recess by etching a portion of the semiconductor wafer; attaching an electronic integrated circuit (EIC) to the semiconductor wafer; optically placing an optical coupler on the recess of the semiconductor wafer to optically couple the optical coupler to the waveguide; forming an encapsulant by overmolding the semiconductor wafer; obtaining an electronic-photonic assembly including the waveguide, the EIC and the optical coupler by singulating the overmolded semiconductor wafer; and attaching an optical assembly to the electronic-photonic assembly, the optical assembly including a detachable plug and a fiber attached to the detachable plug.

In some aspects, the techniques described herein relate to a method, wherein singulating the overmolded semiconductor wafer includes singulating the overmolded semiconductor wafer through the encapsulant and the optical coupler.

In some aspects, the techniques described herein relate to a method, wherein the optical coupler includes: a first reflective portion configured to reflect light received from the waveguide in a first direction that is angled relative to a plane defined by the waveguide; and a second reflective portion configured to reflect the light reflected by the first reflective portion in a second direction that is parallel to the plane defined by the waveguide.

In some aspects, the techniques described herein relate to a method, further including: attaching the electronic-photonic assembly to an interposer; and attaching a processing chip to the interposer, wherein the interposer places the electronic-photonic assembly in communication with the processing chip when the electronic-photonic assembly and the processing chip are attached to the interposer.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in the figures in which they appear.

FIG. 1 is a side view of a photonic device including an electronic-photonic assembly, an optical coupler and a detachable plug holding an optical fiber, in accordance with some embodiments.

FIG. 2A is a side view of a package including an electronic-photonic assembly disposed on an interposer and an optical coupler attached to the electronic-photonic assembly, in accordance with some embodiments.

FIG. 2B is a side view of another package including an electronic-photonic assembly disposed on an interposer, where the interposer is configured as a bridge, in accordance with some embodiments.

FIGS. 3A-3J are cross sectional views illustrating a process for fabricating a photonic device, in accordance with some embodiments. In the fabrication step corresponding to FIG. 3A, a photonic integrated circuit (PIC) is obtained. In the fabrication step corresponding to FIG. 3B, the substrate of the PIC is ground. In the fabrication step corresponding to FIG. 3C, conductive pads are formed on the ground surface of the PIC. In the fabrication step corresponding to FIG. 3D, application-specific integrated circuit (ASICs) are attached to the PIC. In the fabrication step corresponding to FIG. 3E, an underfill is formed between the ASICs and the PIC. In the fabrication step corresponding to FIG. 3F, an optical coupler is attached to the PIC. In the fabrication step corresponding to FIG. 3G, overmolding is performed on the photonic device to form an encapsulant. In the fabrication step corresponding to FIG. 3H, individual PICs are singulated. In the fabrication step corresponding to FIG. 3I, the PIC is attached to a substrate. In the fabrication step corresponding to FIG. 3J, an optical assembly is attached to the PIC.

FIG. 4A is a side view of another photonic device including an electronic-photonic assembly and an optical coupler, in accordance with some embodiments.

FIG. 4B is a side view showing the optical coupler of FIG. 4A in additional detail, in accordance with some embodiments.

### DETAILED DESCRIPTION

The inventors have recognized and appreciated that despite the advantages of optical communication systems, conventional techniques for optical coupler integration face their own set of challenges. Conventional approaches either rely on non-pluggable optical coupler attachments or non-molded architectures that are susceptible to mechanical damage. Non-pluggable designs lack the ability to replace non-functioning fiber attachments, while non-molded architectures leave the photonic integrated circuit (PIC) area exposed, increasing the risk of mechanical damage due to the thin die thickness, typically ranging from 50 to 100 μm.

The inventors have further recognized and appreciated that molded 3D stack architectures are preferred for manufacturing due to their mechanical robustness and compatibility with industry-standard processes. However, traditional molded designs do not offer pluggability, as the optical coupler becomes non-functional if molding gets on the optical coupler. Some embodiments address these challenges to enable high-performance, scalable, and cost-effective optical communication systems.

Chip-on-Wafer-on-Substrate (CoWoS) is an advanced packaging technology that enables integration of multiple chips (e.g., processors, memories and accelerators) on a silicon interposer with an extremely high density of interconnects. CoWoS is used extensively in advanced computer networks because it provides very high bandwidth, large package sizes and seamless integration of high-bandwidth memory.

Described herein are photonic devices that are compatible with existing interposer-based packaging technologies, such as CoWoS. The inventors have recognized and appreciated that the bandwidth of conventional interposer-based packages can be further extended using photonic interfaces. Optical transmission has several advantages over conventional electrical transmission. Photons do not suffer from the same physical limits as electrons when transporting information, especially at high data rates and over long distances. Electrical bandwidth decreases as frequency increases due to the inherent impedance associated with electrical interconnects. Further, electrical loss scales exponentially with distance. By contrast, optical links are characterized by enormous available bandwidth over very long distances. Further advantages include reduced power consumption, immunity to electromagnetic interference and reduced latency.

However, integrating photonic devices with advanced packaging technologies presents a major limitation. Coupling light from the package to external fibers, and vice versa, is extremely challenging. Advanced packages such as those implemented using the CoWoS architecture employ mold encapsulation to stabilize and protect the chip-on-wafer assembly before it is attached to the substrate. Interposers are often implemented as large, thin silicon slabs supporting multiple large chips. The chips are often positioned on the interposer in a way that creates a non-uniform weight distribution, which can cause mechanical stress to the interposer, resulting in warpage and cracking. To prevent these negative effects, advanced packages employ mold encapsulation. Use of mold encapsulation, however, presents a challenge. The encapsulant blocks the side of the PIC that is configured to emit light, thereby preventing optical access to the PIC.

The inventors have developed optical couplers that are configured to facilitate PIC-fiber coupling despite the presence of an encapsulant blocking the side of the PIC. Some embodiments employ optical couplers including a first reflective surface configured to steer light outside of the plane of the PIC and a second reflective surface configured to steer light reflected by the first reflective surface towards the input plane of a fiber. Using this approach, the devices described herein form an optical conduit passing through the encapsulant, thereby providing optical access to the PIC without affecting the mechanical integrity of the package.

The optical couplers described herein are compatible with pluggable connectors, fiber connectors configured to facilitate straightforward connection to the package. This configuration enables optical fibers to be readily removed and replaced, for example in the event of fiber damage, without requiring disposal or replacement of the entire device.

In photonic integrated circuit fabrication, a semiconductor wafer is processed to form a plurality of photonic layouts. Following fabrication of photonic circuitry on the wafer, the wafer is singulated to separate the wafer into individual dies, typically each die corresponding to a reticle shot patterned using lithographic processing. Singulation may be performed using dicing, scribing, laser cutting, or other suitable separation techniques that define edges in each die. One or more optical waveguides are patterned such that an end of a waveguide is positioned proximate to an edge of a singulated die, thereby defining an edge-coupling region. In this region, the guided optical mode propagating within the waveguide transitions toward the die edge and is emitted from a side surface of the die as the waveguide ends, allowing the guided mode to expand and couple into a free-space mode or into an external optical fiber.

The inventors have recognized and appreciated that the edge surface of the PIC can exhibit a degree of surface roughness caused by the singulation process. For example, mechanical dicing, laser cutting, or scribing and breaking may produce edge surfaces having irregularities, chipping, or non-uniform topography. Surface roughness can affect optical behavior in regions where a waveguide end is positioned proximate to the singulated edge. For example, surface roughness may cause scattering, reflection, or mode distortion as light is emitted from the waveguide and exits the PIC, resulting in optical attenuation. In some embodiments, the surface roughness may be reduced through post-singulation processing, such as polishing. However, these techniques are often ineffective.

The inventors have developed edge-coupling schemes configured to reduce the negative effects of side surface roughness. In some embodiments, the schemes developed by the inventors and described herein separate the sidewall from which light exits the PIC upon reaching the end of the waveguide from the rough edge of the PIC. As a result, the degree to which the exiting optical signal interacts with the rough side of the PIC is minimized, mitigating the impact of the edge surface roughness on the integrity of the optical signal.

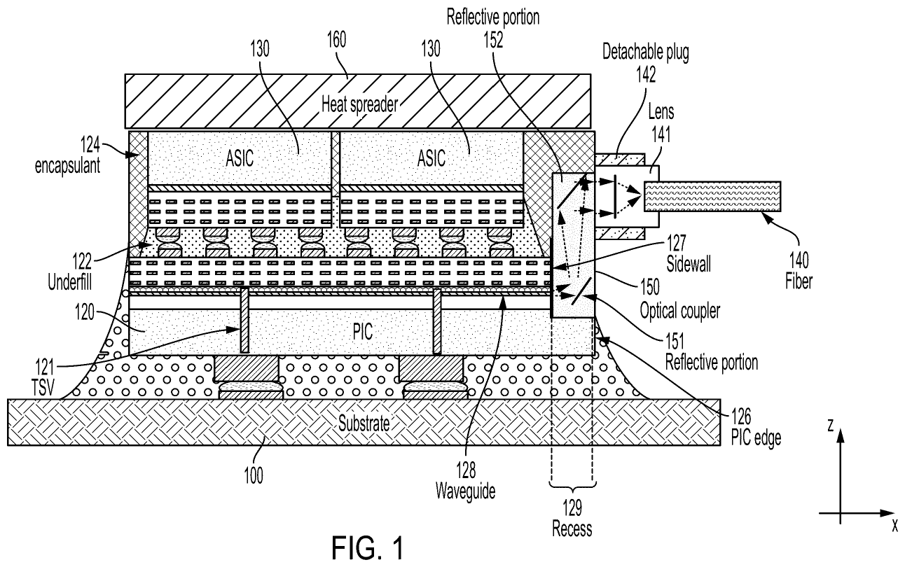

FIG. 1 is a side view of an example of a photonic device implemented in accordance with the techniques described herein. The photonic device of FIG. 1 includes a substrate 100. Substrate 100 may be a printed circuit board (PCB) or an organic substrate, for example. Substrate 100 is configured to route signals generated inside the device to external devices and vice versa. A PIC 120 is disposed on substrate 100, whether directly as shown in FIG. 1 or through an intervening component. PIC 120 may be active in nature in that it may include modulators, photodetectors and/or optical switches. In one example, PIC 120 may be equipped with optical switches to route data to (and from) other devices. PIC 120 may further include a network of waveguides 128. In some embodiments, PIC 120 is made of silicon and PIC waveguides 128 may be made of silicon or silicon nitride. PIC waveguides 128 define a waveguide plane that is parallel to the xy plane of FIG. 1. PIC waveguides 128 route light inside PIC 120 within the waveguide plane. A plurality of through-silicon vias (TSVs) 121 are patterned within PIC 120 and place the electronic circuitry of PIC 120 in electrical communication with substrate 100.

PIC 120 supports one or more ASICs 130. A stack including a PIC and one or more ASICs attached to the PIC is referred to herein as an electronic-photonic assembly. ASICs of the types described herein are also referred to as electronic integrated circuits (EICs). In the arrangement of FIG. 1, a pair of ASICs is disposed on PIC 120, although the PIC may support any other suitable number of ASICs. Each ASIC may include input/output (I/O) circuitry, control circuitry, processing circuitry and/or memory circuitry. I/O circuitry may include serializers/deserializers (SerDes), for example. Control circuitry may include electronic components configured to interface with active photonic circuitry within PIC 120. For example, the control circuitry may include modulator drivers configured to drive optical modulators and trans-impedance amplifiers configured to detect photocurrents produced by photodetectors. In some embodiments, the control circuitry may further include analog-to-digital converters and digital-to-analog converters. Processing circuitry may be implemented as a central processing unit (CPU), a graphics processing unit (GPU), a field programmable gate array (FPGA), a tensor processing unit (TPU), an accelerator, etc. Memory circuitry may be implemented as a high-bandwidth memory (HBM), for example. An underfill 122 fills the space between PIC 120 and ASICs 130, protecting the bumps, pads or other types of electrical features connecting the top surface of PIC 120 to the bottom surfaces of ASICs 130.

An encapsulant 124 at least partially surrounds the electronic-photonic assembly. For example, encapsulant 124 may laterally surround the assembly on two, three or four sides. Encapsulant 124 may form a continuous perimeter around the electronic-photonic assembly, while in other implementations may be discontinuous and may surround only some of the sides of the assembly. Encapsulant 124 may be formed using overmolding techniques (e.g., transfer molding, compression molding or a combination thereof). Encapsulant 124 provides mechanical stability and warpage control, which is particularly desirable in devices in which PIC 120 has been thinned (e.g., resulting in a thickness between 50 μm and 100 μm). Encapsulant 124 reduces this effect. However, encapsulant 124 blocks the side of the PIC that is configured to emit light, thereby preventing optical access. As discussed in detail further below, some embodiments employ optical couplers forming an optical conduit configured to steer light outside the package through encapsulant 124.

A heat spreader 160 is attached to the top surface of ASICs 130. Heat spreader 160 facilitates distribution of heat generated within the package to the external environment. Additionally, heat spreader 160 covers the ASICs, protecting the package from external agents.

An optical assembly, including a detachable plug 142 and an optical fiber 140 pre-attached to the plug, is laterally connected to the electronic-photonic assembly. Detachable plug 142 may be configured to facilitate straightforward connection between fiber 140 and the electronic-photonic assembly. This configuration enables optical fibers to be readily removed and replaced, for example in the event of fiber damage, without requiring disposal or replacement of the entire device. In some embodiments, detachable plug 142 includes a fiber array unit (FAU), a support configured to hold fibers with a predefined pitch. The FAU may include an array of V-grooves or U-grooves—V-shaped or U-shaped channels that have been etched on a support to hold fibers in place. In this arrangement, detachable plug 142 is attached to a side surface of encapsulant 124. The fiber is oriented along a plane substantially parallel to the xy plane (e.g., in the lateral direction in FIG. 1) in the region where the fiber is attached to plug 142. In other arrangements, detachable plug 142 may still be attached to the side surface of encapsulant 124, but the fiber may be oriented along a plane substantially parallel to the zy plane (e.g., in the vertical direction in FIG. 1), or at a slight angle relative to the z-axis (e.g., less than) 20°.

As shown in FIG. 1, waveguide 128 extends near a sidewall of the PIC. In other words, waveguide 128 ends at or near sidewall 127. For example, the end of waveguide 128 may be within 10 μm of sidewall 127. Therefore, when light reaches the end of waveguide 128, it is emitted outside PIC 120 from sidewall 127.

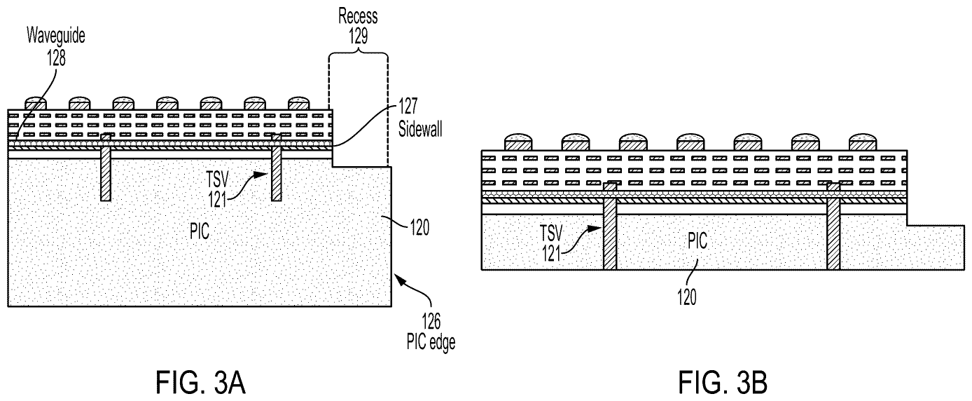

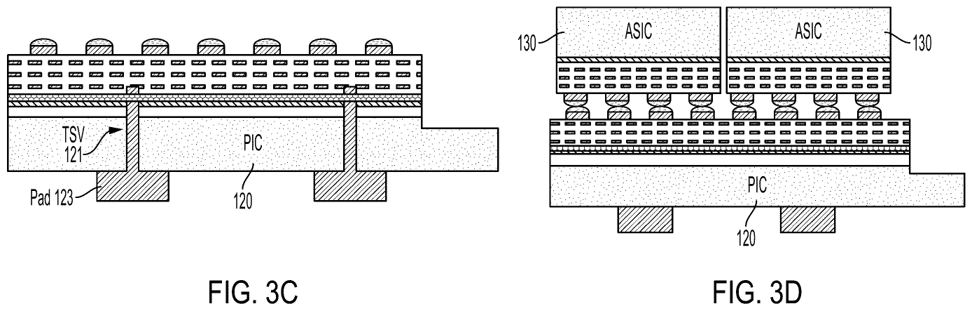

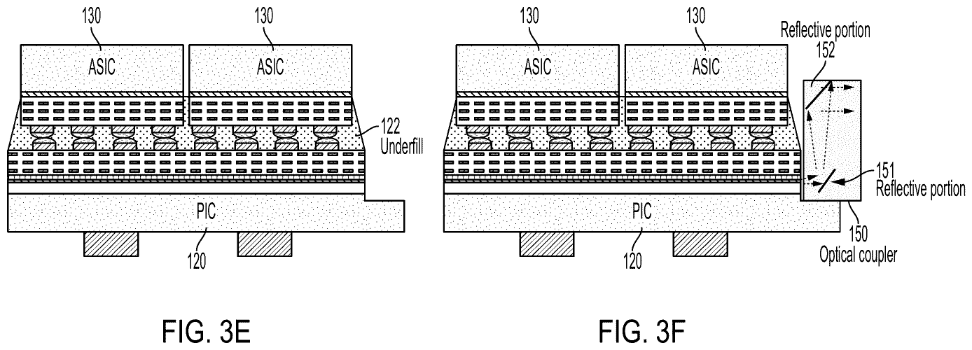

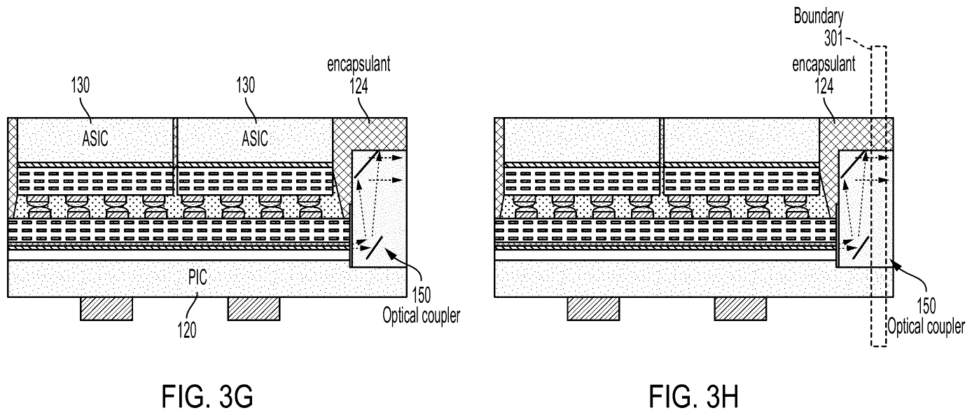

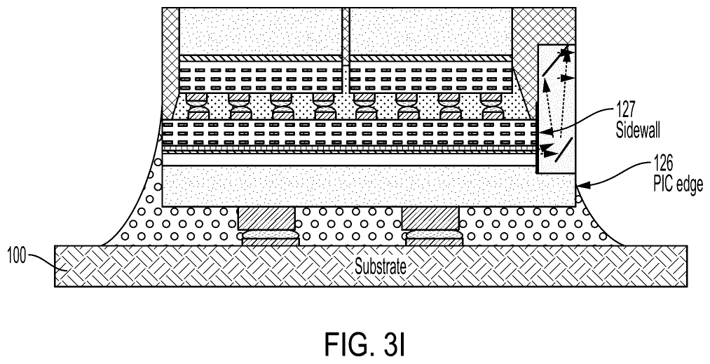

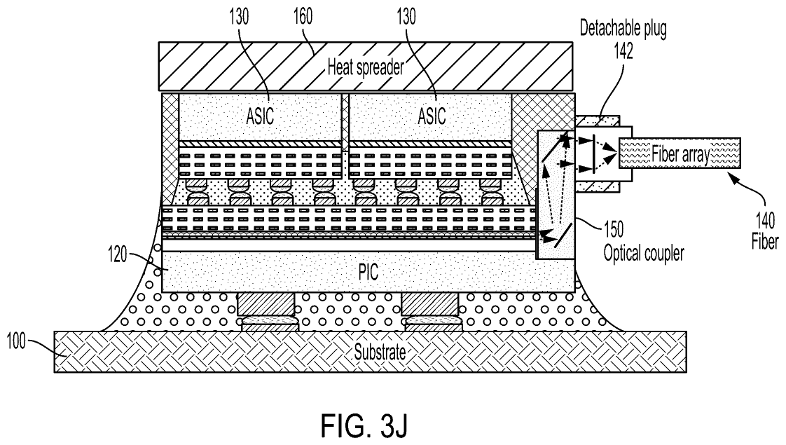

To couple light between PIC 120 and fiber 140, the photonic device includes an optical coupler 150 disposed near sidewall 127. In this implementation, optical coupler 150 is disposed within a recess 129 that has been formed on the top surface of PIC 120, near PIC's edge 126. Recess 129 is described in more detail in connection with FIG. 3A. Recess 129 allows optical coupler 150 to come closer to waveguide 128, enhancing the coupling efficiency. Additionally, the recess separates the sidewall from which light exits the PIC upon reaching the end of the waveguide (sidewall 127) from the rough edge of the PIC (edge 126). This mitigates the impact of the edge surface roughness on the integrity of the optical signal exiting the PIC.

Optical coupler 150 may be made of any material that is transparent to light at the wavelength of interest, including silicon or glass. Optical coupler 150 includes a reflective portion 151 that is configured to reflect light received from waveguide 128 substantially towards the vertical direction (e.g., within 20° of the z-axis), as well as to reflect light received from the substantially vertical direction towards waveguide 128. In some embodiments, reflective portion 151 is angled by approximately 45° relative to the waveguide plane. Reflective portion 151 may be implemented as a conductive surface having a large reflection coefficient (e.g., more than 90%), or may be implemented to operate by total internal reflection. Additionally, optical coupler 150 includes a reflective portion 152 configured to reflect light received from reflective portion 151 towards a direction parallel to the xy plane. In some embodiments, reflective portion 152 is angled by approximately 45° relative to the waveguide plane. Similar to reflective portion 151, reflective portion 152 may be implemented as a conductive surface having a large reflection coefficient, or may be implemented to operate by total internal reflection. Collectively, reflective portions 151 and 152 form an optical conduit configured to steer light exiting PIC 120 towards the input plane of fiber 140 without being absorbed by encapsulant 124. To further increase the PIC-fiber coupling efficiency, detachable plug 142 may include a lens 141 configured to focus light received from reflective portion 152 on the input plane of the fiber.

In some embodiments, optical coupler 150 may include a collimator (not shown in FIG. 1) configured to collimate light emitted from the PIC. The collimator may be disposed along the optical path between PIC 120 and reflective portion 151, between reflective portion 151 and reflective portion 152 or between reflective portion 152 and detachable plug 142. The collimator may be implemented using one or more lenses. Use of a collimator makes the system more robust against misalignments between detachable plug 142 and the optical device.

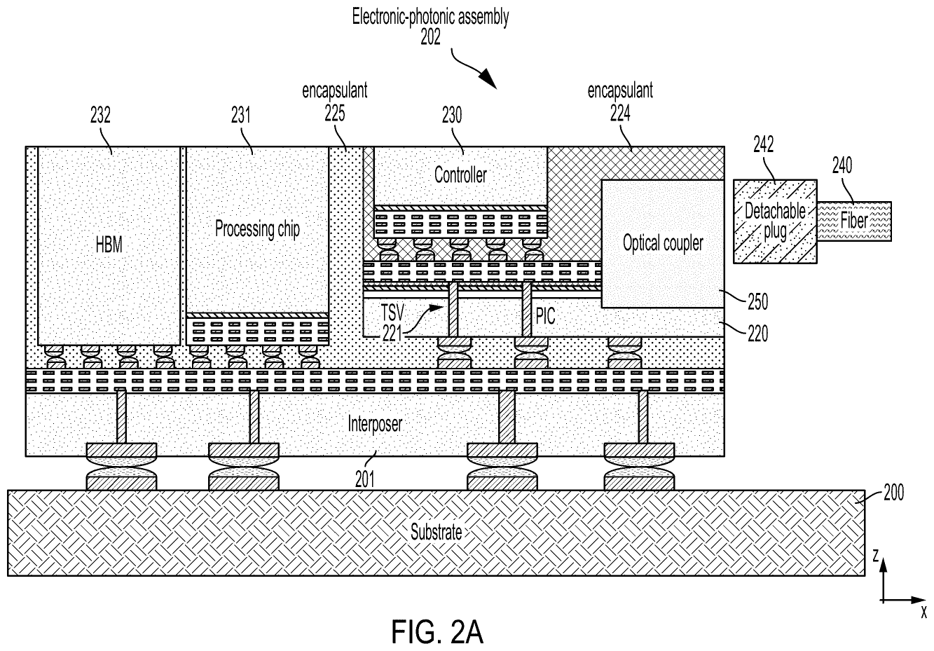

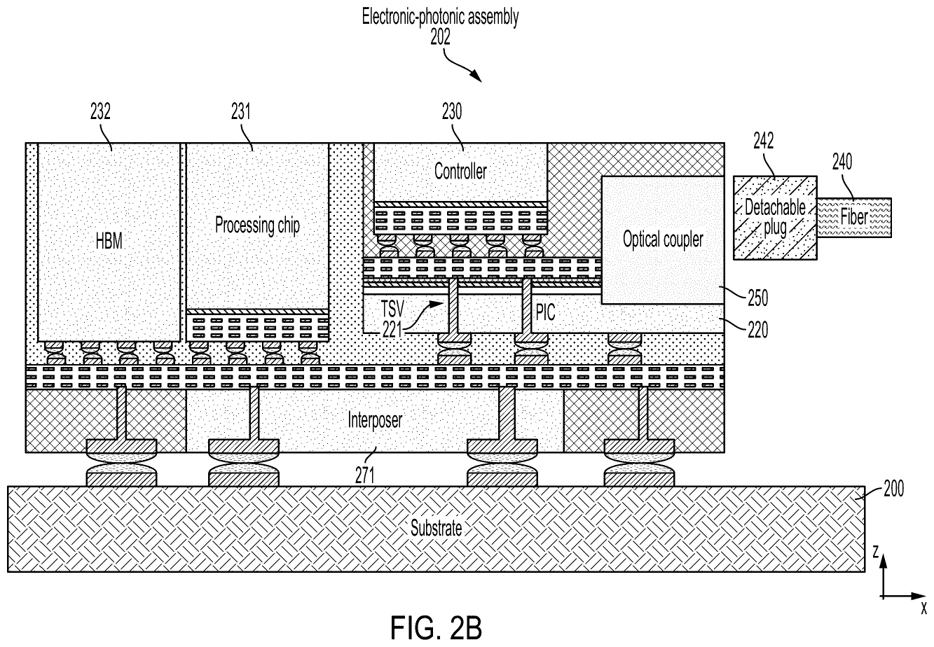

Electronic-photonic assemblies of the types described in connection with FIG. 1 may be used in combination with advanced packaging technologies, including for example with CoWoS. FIG. 2A is a side view of a package including an electronic-photonic assembly disposed on an interposer. The package of FIG. 2A may be implemented in accordance with CoWoS architectures, at least in some embodiments. For example, FIG. 2A may represent a type of CoWoS-S package, in which an interposer is used to interconnect all the packaged chips and assemblies together. Other types of CoWoS-based packaging architectures are also possible, including for example CoWoS-L, in which smaller interposers serve as bridges between selected chips or assemblies. An example of a CoWoS-L package is described below in connection with FIG. 2B.

The package of FIG. 2A includes an interposer 201 attached to a substrate 200. An electronic-photonic assembly 202 is attached to interposer 201. Interposer 201 includes layers of interconnections (interposer interconnections 203) configured to place chips and assemblies in communication with each other. In the example of FIG. 2A, the package includes a processing chip 231 (e.g., a CPU, a GPU, a TPU, an FPGA, etc.), a high-bandwidth memory (HBM) 232 and an electronic-photonic assembly 202, although additional chips and assemblies may be included. Electronic-photonic assembly 202 serves as an optical interface, placing the chips of the package in optical communication with external devices via optical fibers.

Electronic-photonic assembly 202 may be implemented with a similar arrangement as described in connection with FIG. 1. As such, assembly 202 includes a PIC 220, an ASIC (implemented as a controller 230 in this example), an optical coupler 250, a detachable plug 242, a fiber 240 and an encapsulant 224. Controller 230 may include electronic components configured to interface with active photonic circuitry within PIC 220. For example, the control circuitry may include modulator drivers configured to drive optical modulators and trans-impedance amplifiers configured to detect photocurrents produced by photodetectors. Additionally, or alternatively, controller 230 may include serializers/deserializers (SerDes).

An additional encapsulant (encapsulant 225) at least partially surrounds electronic-photonic assembly 202. For example, encapsulant 225 may laterally surround electronic-photonic assembly 202 on two, three or four sides. Encapsulant 225 may form a continuous perimeter around electronic-photonic assembly 202, while in other implementations may be discontinuous and may surround only some of the sides of electronic-photonic assembly 202. Encapsulant 225 may also be formed using overmolding techniques (e.g., transfer molding, compression molding or a combination thereof). While encapsulant 224 provides mechanical stability within electronic-photonic assembly 202, encapsulant 225 provides mechanical stability and warpage control at the package level.

FIG. 2B illustrates another example of a CoWoS package. This package is similar to the one illustrated in FIG. 2A, but is arranged as a CoWoS-L package. As such, interposer 271 serves as a bridge between selected components (between electronic-photonic assembly 202 and processing chip 231 in this example).

FIGS. 3A-3I are cross sectional views illustrating a process for fabricating a photonic device, in accordance with some embodiments. The resulting photonic device may be an implementation of the photonic device of FIG. 1. In some embodiments, the photonic device, once fabricated, may be co-packaged with other electronics chips or assembly, as described above in connection with FIGS. 2A-2B.

The method begins with the fabrication step corresponding to FIG. 3A, in which a PIC 120 is obtained. At this stage, PIC 120 is part of a larger semiconductor wafer having multiple reticle shots patterned thereon. As such, the fabrication steps corresponding to FIGS. 3A-3G are performed at the wafer level (as opposed to the die level). However, the fabrication steps corresponding to FIGS. 3I-3J, following the singulation step of FIG. 3H, are performed at the die level.

PIC 120 may have been pre-processed to photolithographically define various photonic and electronic components, such as waveguide 128 and TSV 121. In some embodiments, PIC 120 may further define a recess 129 near an edge 126 of the PIC. Alternatively, if the recess has not been pre-defined, recess 129 may be photolithographically defined as part of the fabrication method described herein, using etching techniques. Upon forming recess 129, a sidewall 127 is exposed to air. The end of waveguide 128 may be positioned exactly in correspondence with sidewall 127, or within 10 μm of sidewall 127. In operation, light guided by waveguide 128 is emitted through sidewall 127 upon reaching the end of the waveguide.

In the fabrication step corresponding to FIG. 3B, the substrate of PIC 120 is ground. As a result, TSVs 121 are exposed at the lower surface of PIC 120. In the fabrication step corresponding to FIG. 3C, conductive pads 123 are formed on the ground surface of PIC 120. Pads 123 are electrically coupled to TSVs 121, thereby providing electrical access to the electronic circuitry of PIC 120 from the lower surface.

In the fabrication step corresponding to FIG. 3D, ASICs 130 are attached to PIC 120. In the fabrication step corresponding to FIG. 3E, an underfill 122 is formed between ASICs 130 and PIC 120. In the fabrication step corresponding to FIG. 3F, an optical coupler 150 is attached to PIC. In some embodiments, optical coupler 150 is disposed inside recess 129, allowing optical coupler 150 to come closer to the end of waveguide 128.

In the fabrication step corresponding to FIG. 3G, overmolding is performed on the photonic device to form an encapsulant 124. Encapsulant 124 may cover optical coupler 150. By attaching optical coupler 150 to the electronic-photonic assembly before the device is overmolded, the present method creates an optical conduit through the encapsulant while promoting mechanical integrity. In the fabrication step corresponding to FIG. 3H, individual PICs are singulated from the wafer. Singulation may be performed by dicing, scribing, laser cutting, or using other separation techniques along boundary 301. As shown, boundary 301 may pass though encapsulant 124 and optical coupler 150. In the fabrication step corresponding to FIG. 3I, PIC 120 is attached to substrate 100. As further shown in FIG. 3I, following the singulation of FIG. 3H, PIC 120 has an edge 126 that extends outward beyond sidewall 127. Although the surface of edge 126 may be rough due to the singulation step, optical attenuation is reduced because light is emitted from a different surface-sidewall 127. In the fabrication step corresponding to FIG. 3J, detachable plug 142 and heat spreader 160 are attached to the electronic-photonic assembly.

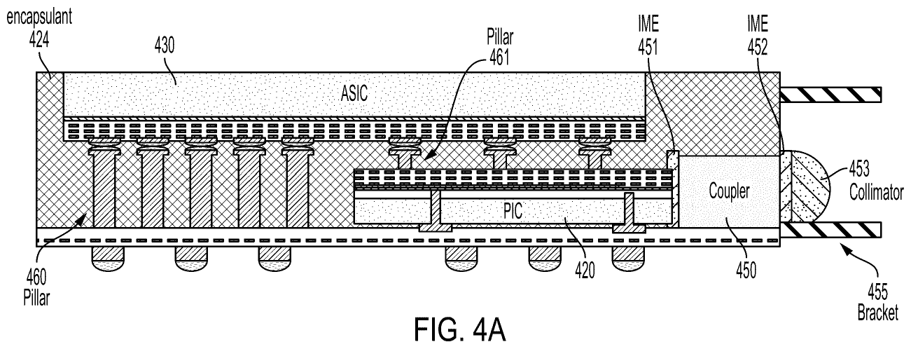

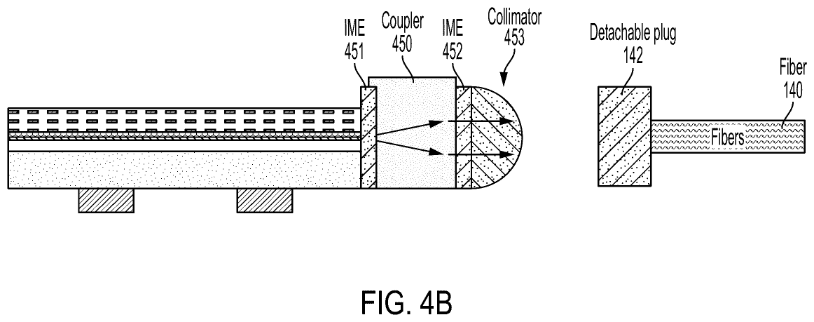

The devices described above use a recess formed in the PIC to permit connection to an optical coupler. The inventors have recognized and appreciated, however, that such a recess can result in significant waste in the area of the PIC die. The recess takes up space that may otherwise be dedicated to additional photonic circuitry. Thus, the inventors have conceived of alternative optical devices that do not employ a recess to attach an optical coupler. FIG. 4A is a side view of a photonic device having an optical coupler that does not rely on a recess. FIG. 4B is a side view showing the optical coupler of FIG. 4A in additional detail. The device of FIG. 4A includes a PIC 420 having characteristics similar to PIC 120. ASIC 430 differs from ASIC 130 in that it is only partially disposed on top of PIC 420. The remaining portion of ASIC 430 extends beyond the edge of PIC 420. An encapsulant 424 at least partially surrounds electronic-photonic assembly. For example, encapsulant 424 may laterally surround electronic-photonic assembly 202 on two, three or four sides. A first set of pillars (pillars 461) connect the bottom surface of ASIC 430 to PIC 420. A second set of pillars (Pillars 460) connect the bottom surface of ASIC 430 to the underlying support (whether a substrate or an interposer). Both sets of pillars traverse encapsulant 424 in the vertical direction.

To couple light between PIC 420 and an external fiber (FIG. 4B), the device includes an optical coupler 450. Similar to optical coupler 150, optical coupler 450 forms an optical conduit through the surrounding encapsulant. Optionally, a collimator 453 may be attached to the side of coupler 450 to perform optical collimation. A set of brackets 455 facilitate attachment of a detachable plug to the package. To promote optical coupling between the PIC and the fiber while minimizing back-reflections, some embodiments employ index-matching epoxy (IME). IME 451 is disposed between the edge of PIC 420 and coupler 450, and IME 452 is disposed between coupler 450 and collimator 453.

Collimation is generally referred to as the effect by which a device takes divergent or convergent optical rays and makes them parallel. Collimators, in essence, are devices that straighten optical beams. As used herein, however, the terms “collimator” and “collimation” should be interpreted more broadly to include scenarios in which a beam's angle of divergence (or, in the opposite direction, the angle of convergence) is reduced. In other words, the output beam needs not be perfectly parallel, but may be quasi-parallel. In one example, a collimator may take a beam having an angle of divergence of approximately 10° and may output a beam having an angle of divergence of approximately 3°. In another example, a collimator may take a beam having an angle of divergence of approximately 10° and may output a beam having an angle of convergence of approximately 3°.

As further shown in FIG. 4B, collimator 453 defines a convex surface, for example in the shape of a dome. The curvature of the convex surface is designed to collimate the beam emitted by the PIC and passing through coupler 450, making the system more robust against misalignments between the detachable plug and the optical device.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

As used herein, terms such as “above,” “below,” “over,” “under,” “adjacent,” “upper,” “top,” “lower,” “bottom,” “vertical,” “horizontal,” “lateral,” and similar positional or directional descriptors are used solely to describe the relative arrangement and orientation of features as illustrated in the drawings and are not intended to be limiting. Such terms do not require any particular orientation of the device in use, manufacture, or operation, and the described features may be oriented in any direction without departing from the scope of the present disclosure. Moreover, these terms are not intended to imply any absolute position, gravitational reference, or fixed spatial relationship, and components described as being positioned using positional or directional descriptors may be arranged in different relative positions, including inverted, rotated, or otherwise reoriented configurations, while still performing the same function in substantially the same way to achieve substantially the same result.

What is claimed is:

1. A photonic device, comprising:
an electronic-photonic assembly comprising:
a photonic integrated circuit (PIC) comprising a waveguide extending near a sidewall of the PIC;
an electronic integrated circuit (EIC) attached to the PIC; and
an encapsulant at least partially encapsulating the EIC;
an optical assembly comprising a detachable plug and a fiber attached to the detachable plug; and
an optical coupler between the sidewall of the PIC and the optical assembly, wherein the optical coupler is configured to couple light received from the waveguide to the fiber.

2. The photonic device of claim 1, wherein the optical coupler comprises:
a first reflective portion configured to reflect the light received from the waveguide in a first direction that is angled relative to a plane defined by the waveguide; and
a second reflective portion configured to reflect the light reflected by the first reflective portion in a second direction that is parallel to the plane defined by the waveguide.

3. The photonic device of claim 2, wherein the first and second reflective portions are angled by approximately 45° relative to the plane defined by the waveguide.

4. The photonic device of claim 1, wherein the optical coupler is made of silicon.

5. The photonic device of claim 1, wherein the PIC defines a recess near an edge of the PIC, and wherein the optical coupler is disposed in the recess.

6. The photonic device of claim 1, wherein the optical coupler extends through the encapsulant.

7. The photonic device of claim 1, wherein the optical coupler comprises a collimator configured to collimate the light received from the waveguide.

8. The photonic device of claim 7, wherein the collimator comprises a convex surface.

9. A photonic device, comprising:
a chip-on-wafer-on-substrate (CoWoS) package comprising an interposer and an electronic-photonic assembly disposed on the interposer, the electronic-photonic assembly comprising:
a photonic integrated circuit (PIC) comprising a waveguide extending near a sidewall of the PIC;
an electronic integrated circuit (EIC) attached to the PIC; and
a first encapsulant at least partially encapsulating the EIC;
an optical assembly comprising a detachable plug and a fiber attached to the detachable plug;
an optical coupler between the sidewall of the PIC and the optical assembly, wherein the optical coupler is configured to couple light received from the waveguide to the fiber; and
a second encapsulant at least partially encapsulating the electronic-photonic assembly.

10. The photonic device of claim 9, further comprising second and third EICs disposed on the interposer, wherein the interposer places the electronic-photonic package in electrical communication with at least one between the second and third EICs.

11. The photonic device of claim 10, wherein:
the first EIC comprises electronic circuitry configured to control active photonic circuitry of the PIC,
the second EIC comprises a processing chip, and
the third EIC comprises a high-bandwidth memory.

12. The photonic device of claim 9, wherein the optical coupler comprises:
a first reflective portion configured to reflect the light received from the waveguide in a first direction that is angled relative to a plane defined by the waveguide; and
a second reflective portion configured to reflect the light reflected by the first reflective portion in a second direction that is parallel to the plane defined by the waveguide.

13. The photonic device of claim 12, wherein the first and second reflective portions are angled by approximately 45° relative to the plane defined by the waveguide.

14. The photonic device of claim 9, wherein the PIC defines a recess near an edge of the PIC, and wherein the optical coupler is disposed in the recess.

15. The photonic device of claim 9, wherein the optical coupler comprises a collimator configured to collimate the light received from the waveguide.

16. The photonic device of claim 15, wherein the collimator comprises a convex surface.

17. A method for fabricating a photonic device, comprising:
obtaining a semiconductor wafer having a waveguide;
forming a recess by etching a portion of the semiconductor wafer;
attaching an electronic integrated circuit (EIC) to the semiconductor wafer;
optically placing an optical coupler on the recess of the semiconductor wafer to optically couple the optical coupler to the waveguide;
forming an encapsulant by overmolding the semiconductor wafer;
obtaining an electronic-photonic assembly comprising the waveguide, the EIC and the optical coupler by singulating the overmolded semiconductor wafer; and
attaching an optical assembly to the electronic-photonic assembly, the optical assembly comprising a detachable plug and a fiber attached to the detachable plug.

18. The method of claim 17, wherein singulating the overmolded semiconductor wafer comprises singulating the overmolded semiconductor wafer through the encapsulant and the optical coupler.

19. The method of claim 17, wherein the optical coupler comprises:
a first reflective portion configured to reflect light received from the waveguide in a first direction that is angled relative to a plane defined by the waveguide; and
a second reflective portion configured to reflect the light reflected by the first reflective portion in a second direction that is parallel to the plane defined by the waveguide.

20. The method of claim 17, further comprising:
attaching the electronic-photonic assembly to an interposer; and
attaching a processing chip to the interposer, wherein the interposer places the electronic-photonic assembly in communication with the processing chip when the electronic-photonic assembly and the processing chip are attached to the interposer.
